(19) United States
(12) Patent Application Publication
(10) Pub. No.: US 2013/0010926 A1
(43) Pub. Date: Jan. 10, 2013

(54) RADIATION DETECTION DEVICE, RADIOGRAPHIC APPARATUS AND RADIOGRAPHIC SYSTEM

(76) Inventor: Takuji Tada, Kanagawa (JP)

(21) Appl. No.: 13/634,861

(22) PCT Filed: Mar. 29, 2011
(86) PCT No.: PCT/JP2011/058950

§ 371 Date: Sep. 13, 2012

(30) Foreign Application Priority Data
Mar. 30, 2010 (JP) 2010-079917
Sep. 30, 2010 (JP) 2010-223291
Jan. 19, 2011 (JP) 2011-009177

(51) Int. Cl. G21K 1/06; G01N 23/04

(52) U.S. Cl. 378/62; 378/145

(57) ABSTRACT

A radiographic system includes an X-ray source, a first transmission type grating, a second transmission type grating, a scanning mechanism, and a flat panel detector, and an arithmetic processing section. The first transmission type grating is constituted by connecting a plurality of first grating pieces in a first direction, and the second transmission type grating is constituted by connecting a plurality of second grating pieces in the first direction. In projection onto the flat panel detector with the focus of the X-ray source as a viewpoint, at least one pixel is interposed between each pixel of the flat panel detector onto which a connection point of two adjacent first grating pieces is projected and each pixel onto which a connection portion of two adjacent second grating pieces is projected.

### TECHNICAL FIELD

The present invention relates to a radiation detection device which detects radiation, such as X-rays, having passed through a subject, and a radiographic apparatus and a radiographic system including the same.

### BACKGROUND ART

X-rays are used as a probe for seeing through a subject since the X-rays are attenuated depending on the atomic number of an element, which forms a material, and the density and thickness of the material. Imaging using X-rays has been widespread in fields such as medical diagnosis and non-destructive inspection.

In a general X-ray imaging system, a subject is disposed between an X-ray source which emits X-rays and an X-ray image detector which detects X-rays and a transmission image of the subject is captured. In this case, each X-ray emitted from the X-ray source toward the X-ray image detector is attenuated (absorbed) by the amount corresponding to the difference in properties (atomic number, density, and thickness) of materials present on the path to the X-ray image detector and is then incident on each pixel of the X-ray image detector. As a result, an X-ray absorption image of the subject is detected by the X-ray image detector and imaged. As the X-ray image detector, not only the combination of an X-ray intensifying screen and a film or photostimulable phosphor but also a flat panel detector (FPD) using a semiconductor circuit is widely used.

However, since the X-ray absorption ability of the material decreases as the atomic number of the element constituting the material decreases, there is a problem in that the contrast of an image sufficient as an X-ray absorption image is not obtained in a soft biological tissue or a soft material. For example, most components of a cartilaginous portion, which forms the joint of a human body, and joint fluid around the cartilaginous portion are water. Accordingly, since the difference between their X-ray absorption amounts is small, it is difficult to acquire the intensity difference.

In recent years, in order to solve such a problem, X-ray phase imaging has been actively studied which is for acquiring an image (hereinafter, referred to as a phase contrast image) based on a phase change (angle change) of X-rays by a subject instead of an intensity change of X-rays by a subject. Generally, it is known that interaction between the phases of X-rays is stronger than interaction between the intensities of X-rays when X-rays are incident on a material. For this reason, in the X-ray phase imaging using a phase difference, an image with high contrast can be acquired even in the case of a weak absorption material with a low X-ray absorption ability. As one of such an X-ray phase imaging system, an X-ray imaging system using an X-ray Talbot interferometer which includes two transmission type diffraction gratings (phase grating or absorption grating) and an X-ray image detector has been recently proposed (for example, see Patent Document 1 (WO-A-2004/058070)).

The X-ray Talbot interferometer is formed by disposing a first diffraction grating (phase grating or absorption grating) behind a subject, disposing a second diffraction grating (absorption grating) at the downstream side by the specific distance (Talbot interference distance) determined by the grating pitch of the first diffraction grating and the X-ray wavelength, and disposing an X-ray image detector therebehind. The Talbot interference distance is a distance in which X-rays transmitted through the first diffraction grating form a self-image by the Talbot interference effect, and this self-image is modulated by interaction (phase change) of the subject, which is disposed between the X-ray source and the first diffraction grating, and X-rays.

In the X-ray Talbot interferometer, moiré fringes generated by superposition of the self-image of the first diffraction grating and the second diffraction grating are detected, and the phase information of the subject is acquired by analyzing a change of the moiré fringes by the subject. As an example of the method of analyzing moiré fringes, a fringe scanning method is proposed. According to the fringe scanning method, imaging is performed a plural number of times while performing translational movement of the second diffraction grating with respect to the first diffraction grating by a scanning pitch, which is obtained by equal division of the grating pitch, in a direction almost parallel to the surface of the first diffraction grating and in a direction almost perpendicular to the lattice direction (strip direction) of the first diffraction grating, and the angle distribution (phase-shifted differential image) of X-rays refracted at the subject is acquired from a change in the signal value of each pixel obtained by the X-ray image detector. On the basis of this angle distribution, a phase contrast image of the subject can be acquired.

In an X-ray imaging system using an X-ray Talbot interferometer, it is necessary to properly provide the first and second diffraction gratings of a large size for expanding the imaging range. However, it is necessary that the first and second diffraction gratings have a high aspect ratio with a grating pitch in the order of μm, making it difficult to accurately manufacture a grating of a large size. Thus, a technique has been suggested in which each of the first and second diffraction gratings is constituted by a plurality of grating pieces, and each grating piece is of a comparatively small size (for example, see Patent Document 2 (JP-A-2007-203061)).

Similarly to X-rays, with regard to visible light (for example, He—Ne laser or the like) having high coherence, phase imaging based on imaging with a Talbot interferometer has been contrived earlier than X-ray phase imaging (for example, see Non-Patent Document 1 (Hector Canabal and two other persons, “Improved phase-shifting method for automatic processing of moire deflectograms”, APPLIED OPTICS, September 1998, Vol 37, No. 26, p. 6227-6233)).

### SUMMARY OF INVENTION

### Technical Problem

When each of the first and second diffraction gratings is constituted by a plurality of grating pieces, normal fringe scanning is not carried out in the connection portion of two adjacent grating pieces, and the pixel of an X-ray image detector on which X-rays having passed through the connection portion are incident becomes a defective region where the phase information of the X-rays cannot be accurately obtained. For this reason, in Patent Document 2, the phase information of the X-rays in the pixel which becomes the defective region is interpolated on the basis of the phase information of the X-rays in a peripheral pixel, and the first and second diffraction gratings are adjusted such that the occurrence of the defective region is suppressed, but there is no description of a specific countermeasure.

An object of the invention is to the achieve expansion of an X-ray exposure field and to maintain image quality in radiation imaging for phase imaging of a subject.

### Solution to Problem

A radiation detection device includes a first grating, a second grating which has a periodic pattern substantially the same as the periodic pattern of a radiation image of the first grating formed by radiation having passed through the first grating, and a radiation image detector which detects the radiation image masked with the second grating. Each of the first grating and the second grating includes a plurality of grating pieces which are arranged at least in a first direction within a plane crossing the traveling direction of radiation passing therethrough. In projection onto the radiation image detector with a radiation focal point as a viewpoint, the radiographic image detector includes a first pixel group onto which the connection portion of adjacent grating pieces of the first grating in the first direction is projected, a second pixel group onto which the connection portion of adjacent grating pieces of the second grating in the first direction is projected, and a third pixel group excluding the first pixel group and the second pixel group. At least one pixel which belongs to the third pixel group is interposed between each pixel which belongs to the first pixel group and each pixel which belongs to the second pixel group.

### Advantageous Effects of Invention

According to the aspect of the invention, each of the first grating and the second grating is constituted by a plurality of grating pieces, and the radiation exposure field can be easily expanded. At least one pixel is interposed between each pixel of the radiation image detector onto which the connection portion of two adjacent grating pieces of the first grating is projected and each pixel onto which the connection portion of two adjacent grating pieces of the second grating is projected, such that a pixel in which the phase information of radiation can be obtained can be provided around the pole of each pixel onto which the connection portion is projected. Therefore, it is possible to accurately interpolate the phase information of radiation in each pixel onto which the connection portion is projected by using the phase information of radiation in a pixel around the pole, and to maintain image quality.

### BRIEF DESCRIPTION OF THE DRAWINGS

FIG. 1 is a schematic view showing the configuration of an example of a radiographic system for illustrating an embodiment of the invention.

FIG. 2 is a block diagram showing the control configuration of the radiographic system shown in FIG. 1.

FIG. 3 is a schematic view showing the configuration of a radiation image detector.

FIG. 4 is a perspective view showing the configuration of first and second gratings.

FIG. 5 is a side view showing the configuration of the first and second gratings.

FIGS. 6A to 6C are schematic views each showing a mechanism for changing the period of a moire fringe when the first and second gratings overlap each other.

FIG. 7 is a schematic view illustrating refraction of radiation by a subject.

FIG. 8 is a schematic view illustrating a fringe scanning method.

FIG. 9 is a graph showing a signal of each pixel of the radiation image detector according to fringe scanning.

FIG. 10 is a schematic view showing an example of the arrangement of the first and second gratings.

FIG. 11 is a schematic view showing the arrangement of the first and second gratings shown in FIG. 10 in more detail.

FIG. 12 is a schematic view showing the arrangement of the first and second gratings shown in FIG. 10 in more detail.

FIG. 13 is a schematic view showing another example of the configuration of the first and second gratings.

FIG. 14 is a schematic view showing another example of the configuration of the first and second gratings.

FIG. 15 is a schematic view showing another example of the configuration of the first and second gratings.

FIG. 16 is a schematic view showing another example of the configuration of the first and second gratings.

FIG. 17 is a schematic view showing another example of the configuration of the first and second gratings.

FIG. 18 is a schematic view showing projection of a connection portion of each of the first and second gratings shown in FIG. 17 onto the radiation image detector.

FIG. 19 is a schematic view showing the configuration of another example of a radiographic system for illustrating an embodiment of the invention.

### DESCRIPTION OF EMBODIMENTS

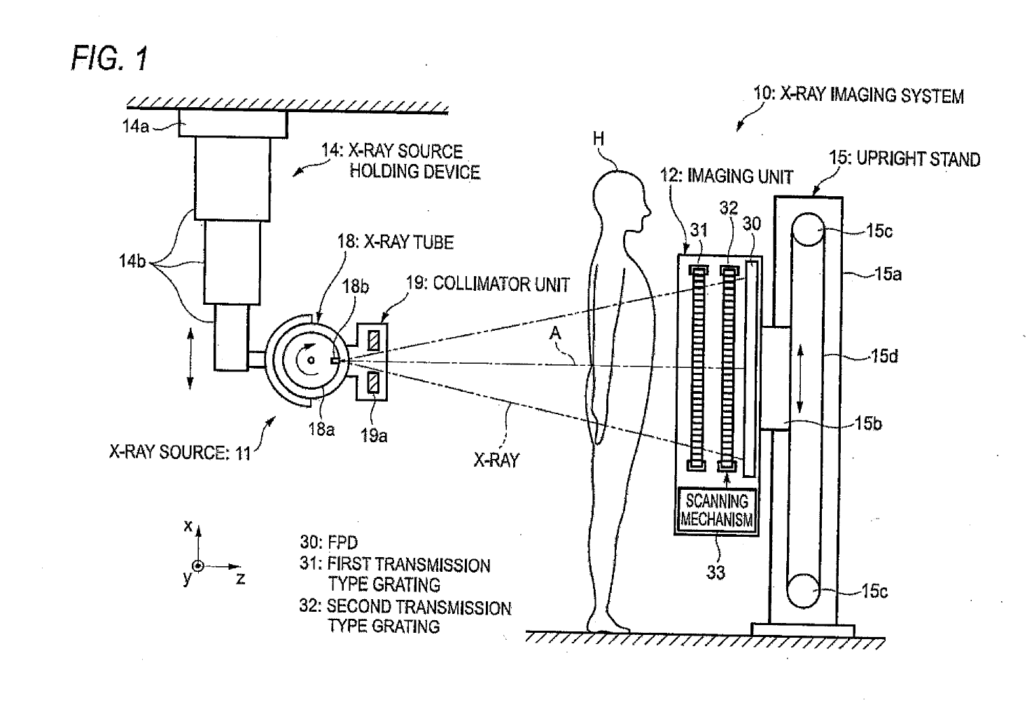

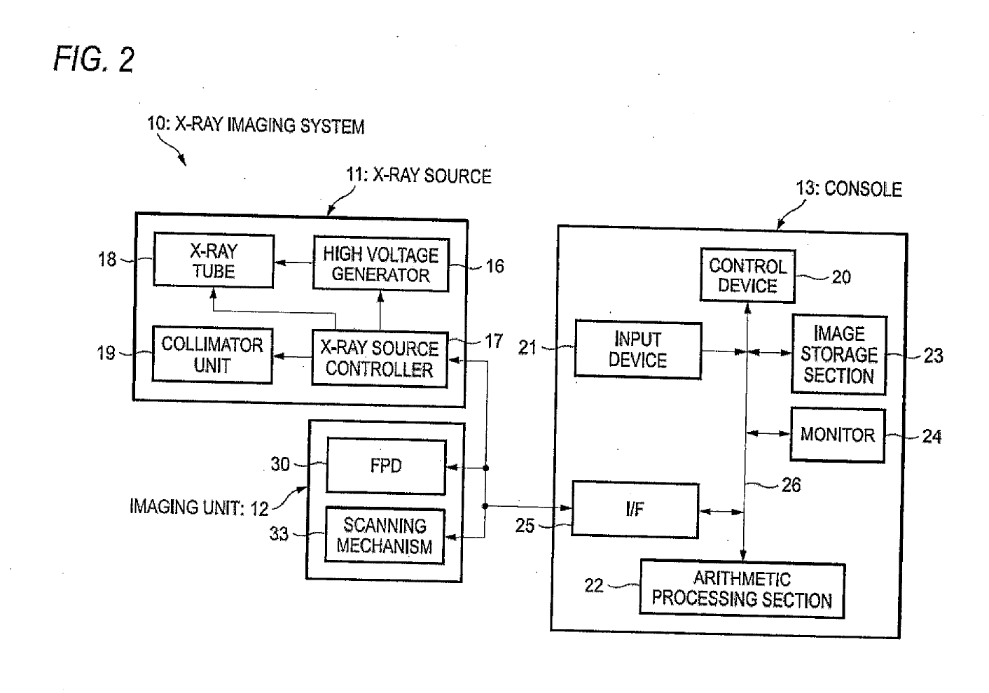

An X-ray imaging system 10 shown in FIGS. 1 and 2 is an X-ray diagnostic apparatus which images a subject (patient) H in a standing state and mainly includes: an X-ray source 11 which emits X-rays to the subject H; an imaging unit 12 which is disposed opposite the X-ray source 11 and which detects X-rays transmitted through the subject H from the X-ray source 11 and generates the image data; and a console 13 which controls an exposure operation of the X-ray source 11 or an imaging operation of the imaging unit 12 on the basis of an operation of the operator and which generates a phase contrast image by arithmetic processing of the image data acquired by the imaging unit 12.

The X-ray source 11 is held by an X-ray source holding device 14 suspended from the ceiling so as to freely move in a vertical direction (x direction). The imaging unit 12 is held by an upright stand 15 installed on the floor so as to freely move in the vertical direction.

The X-ray source 11 includes an X-ray tube 18, which generates X-rays by a high voltage applied from a high voltage generator 16 on the basis of control of an X-ray source controller 17, and a collimator unit 19 having a movable collimator 19a that restricts an exposure field on the basis of control of the X-ray source controller 17 so that X-rays, which are not emitted to the inspection region of the subject H, among the X-rays emitted from the X-ray tube 18 are blocked. The X-ray tube 18 is of an anode rotation type, and generates X-rays by emitting electron beams from a filament (not shown) as an electron emission source (negative electrode) and making the electron beams collide with a rotating anode 18a which rotates at a predetermined speed. A portion of the rotating anode 18a colliding with electron beams becomes an X-ray focal point 18b.

The X-ray source holding device 14 includes a carriage 14a, which is formed to freely rotate in a horizontal direction (z direction) by a ceiling rail (not shown) installed on the ceiling, and a plurality of columns 14b connected to carriage 14a in the vertical direction. A motor (not shown) which changes the position of the X-ray source 11 in the vertical direction by expanding or contracting the columns 14b is provided in the carriage 14a.

The upright stand 15 is fixed to a main body 15a installed on the floor such that a holding section 15b, which holds the imaging unit 12, freely moves in the vertical direction. The holding section 15b is connected to an endless belt 15d hanging between two pulleys 15c, which are separated from each other in the vertical direction, and is driven by a motor (not shown) that rotates the pulleys 15c. Driving of this motor is controlled by a control device 20 of the console 13, which will be described later, on the basis of a setting operation of an operator.

In addition, a position sensor (not shown), such as a potentiometer which detects the position of the imaging unit 12 in the vertical direction by measuring the amount of movement of the pulleys 15c or the endless belt 15d, is provided in the upright stand 15. The detection value of the position sensor is supplied to the X-ray source holding device 14 through a cable or the like. The X-ray source holding device 14 moves the X-ray source 11 so as to follow the vertical movement of the imaging unit 12 by expanding or contracting the columns 14b on the basis of the supplied detection value.

The control device 20 including a CPU, a ROM, a RAM, and the like is provided in the console 13. An input device 21 which is used when an operator inputs an imaging instruction or the instruction content, an arithmetic processing section 22 which generates an X-ray image by performing arithmetic processing of image data acquired by the imaging unit 12, a storage section 23 which stores an X-ray image, a monitor 24 which displays an X-ray image or the like, and an interface (I/F) 25 connected to each section of the X-ray imaging system 10 are connected to the control device 20 through a bus 26.

As the input device 21, for example, a switch, a touch panel, a mouse, and a keyboard may be used. X-ray imaging conditions, such as an X-ray tube voltage or an X-ray exposure time, an imaging timing, and the like are input by operation of the input device 21. The monitor 24 is formed by a liquid crystal display or the like and displays an X-ray image or characters, such as X-ray imaging conditions, by control of the control device 20.

A flat panel detector (FPD) 30 formed by a semiconductor circuit and first and second transmission type gratings 31 and 32 for detecting a phase change (angle change) of X-rays by the subject H and performing phase imaging are provided in the imaging unit 12. The FPD 30 is disposed such that the detection surface is perpendicular to the optical axis A of X-rays emitted from the X-ray source 11. The first and second transmission type gratings 31 and 32 are disposed between the FPD 30 and the X-ray source 11 and will be described in detail later. In addition, a scanning mechanism 33 which changes the relative position of the second transmission type grating 32 with respect to the first transmission type grating 31 by performing translational movement of the second transmission type grating 32 in the vertical direction is provided in the imaging unit 12. For example, the scanning mechanism 33 is formed by an actuator, such as a piezoelectric element.

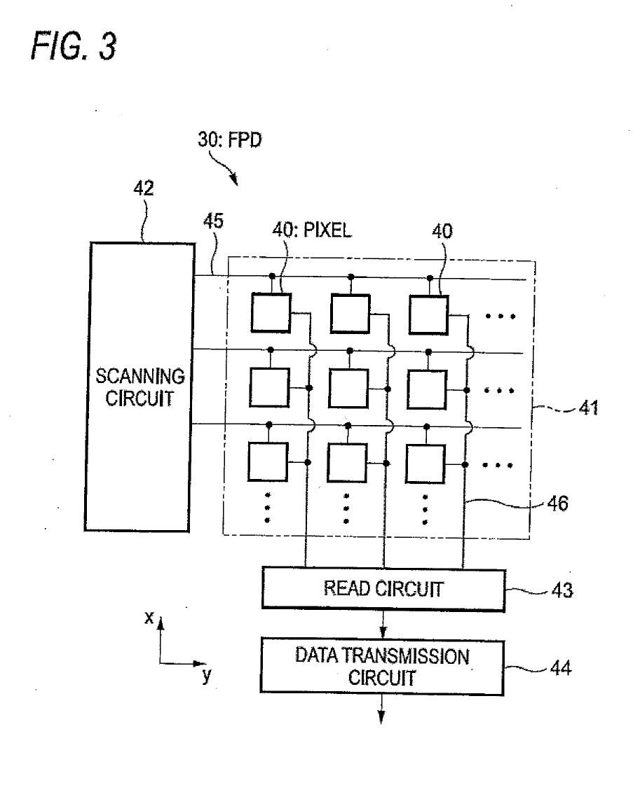

As shown in FIG. 3, the FPD 30 includes: an image receiving section 41 in which a plurality of pixels 40, which converts X-rays into electric charges and stores the electric charges, is arrayed on an active matrix substrate in the xy direction in a two-dimensional manner; a scanning circuit 42 which controls a read timing of electric charges from the image receiving section 41; a read circuit 43 which reads an electric charge stored in each pixel 40 and converts the electric charge into image data and stores it; and a data transmission circuit 44 which transmits the image data to the arithmetic processing section 22 through the I/F 25 of the console 13. In addition, the scanning circuit 42 and each pixel 40 are connected to each row by a scanning line 45, and the read circuit 43 and each pixel 40 are connected to each column by a signal line 46.

Each pixel 40 may be formed as a direct conversion type element in which a conversion layer (not shown) formed of amorphous selenium or the like directly converts X-rays into electric charges and the converted electric charges are stored in a capacitor (not shown) connected to an electrode below the conversion layer. A TFT switch (not shown) is connected to each pixel 40, and a gate electrode, a source electrode, and a drain electrode of the TFT switch are connected to the scanning line 45, the capacitor, and the signal line 46, respectively. When a TFT switch is turned ON by a driving pulse from the scanning circuit 42, electric charges stored in the capacitor are read to the signal line 46.

In addition, each pixel 40 may also be formed as an indirect conversion type X-ray detection element in which a scintillator (not shown) formed of gadolinium oxide (Gd₂O₃), cesium iodide (CsI), or the like converts X-rays into visible light first, the converted visible light is converted into electric charges by a photodiode (not shown), and the electric charges are stored. In addition, the X-ray image detector is not limited to the FPD based on the TFT panel, and it is also possible to use various kinds of X-ray image detectors based on solid-state imaging devices, such as a CCD sensor and a CMOS sensor.

The read circuit 43 is formed by an integration amplifier circuit, an A/D converter, a correction circuit, and an image memory (not shown). The integration amplifier circuit integrates an electric charge output from each pixel 40 through the signal line 46, converts it into a voltage signal (image signal), and inputs it into the A/D converter. The A/D converter converts the input image signal into digital image data and inputs it to the correction circuit. The correction circuit performs offset correction, gain correction, and linearity correction for the image data and stores the image data after correction in the image memory. In addition, correction of the amount of exposure of X-rays or exposure distribution (so-called shading), correction of pattern noise (for example, a leak signal of a TFT switch) depending on the control conditions (driving frequency or read period) of the FPD 30, and the like may be included as correction processing of the correction circuit.

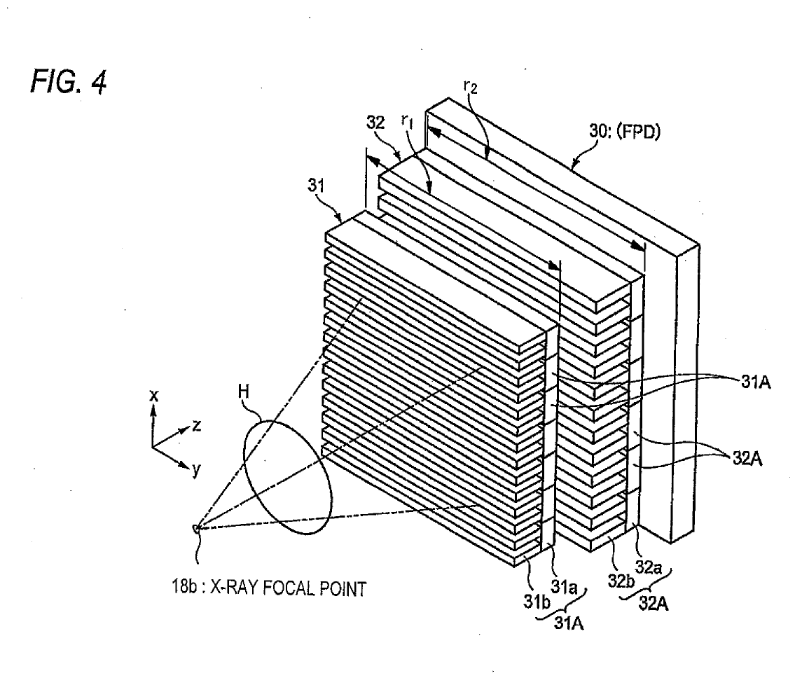

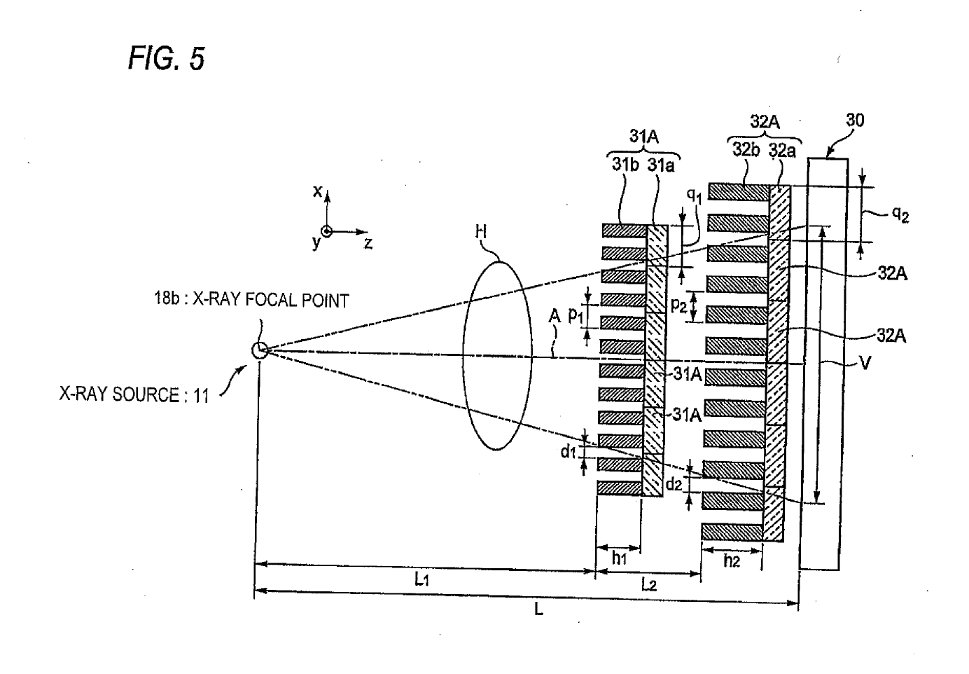

As shown in FIGS. 4 and 5, the first transmission type grating 31 is constituted by connecting a plurality of first grating pieces 31A, and two adjacent first grating pieces 31A are connected to each other by, for example, an adhesive or the like. Each of the first grating pieces 31A is constituted by a substrate 31a and a plurality of X-ray blocking sections 31b arranged in the substrate 31a. The second transmission type grating 32 is also constituted by connecting a plurality of second grating pieces 32A, and each of the second grating pieces 32A is constituted by a substrate 32a and a plurality of X-ray blocking sections 32b arranged in the substrate 32a. The substrates 31a and 32a are formed of an X-ray transmissive member, such as glass, through which X-rays pass.

The X-ray blocking sections 31b and 32b are linear members which extend in one direction (in the example of the drawing, the y direction) within the plane perpendicular to the optical axis A of X-rays. As the material for each of the X-ray blocking sections 31b and 32b, a material which is excellent in X-ray absorption is preferably used. For example, a metal, such as gold or platinum, is preferably used. The X-ray blocking sections 31b and 32b can be formed by a metal plating method or an evaporation method.

The X-ray blocking sections 31b are arranged at a predetermined distance d₁ in a predetermined period p₁ in a direction (in the example of the drawing, the x direction) perpendicular to the one direction within the plane perpendicular to the optical axis A of X-rays. Similarly, the X-ray blocking sections 32b are arranged at a predetermined distance d₂ in a predetermined period p₁ in the direction (in the example of the drawing, the x direction) perpendicular to the one direction within the plane perpendicular to the optical axis A of X-rays. The first and second transmission type gratings 31 and 32 impart a difference in intensity to incident X-rays, not a difference in phase. For this reason, the first and second transmission type gratings 31 and 32 are called an absorption type grating or amplitude type grating from among transmission type gratings. A slit portion (the region of the distance d₁ or d₂) may not be an opening, or an opening may be filled with an X-ray low-absorptive material, such as a polymer or a light metal.

The first and second transmission type gratings 31 and 32 are configured so as to geometrically project X-rays having passed through the slit portions, regardless of the presence/absence of the Talbot interference effect. Specifically, the distance d₁ or d₂ is set to a value sufficiently greater than the peak wavelength of X-rays exposed from the X-ray source 11, such that most X-rays included in the exposed X-rays pass through the slit portion with straightness, without being diffracted. For example, when tungsten is used for the above-described rotating anode 18a and the tube voltage is 50 kV, the peak wavelength of X-rays is about 0.4 Å. In this case, if the distance d₁ or d₂ is set to about 1 to 10 μm, most X-rays are geometrically projected without being diffracted in the slit portion.

X-rays emitted from the X-ray source 11 are cone beams with an X-ray focal point 18b as a light-emitting point, not parallel beams. For this reason, a projection image (hereinafter, this projection image is called a GI image) which passes through the first transmission type grating 31 and is projected is expanded in proportion to the distance from the X-ray focal point 18b. The grating pitch p₂ of the second transmission type grating 32 is determined so as to substantially coincide with the periodic pattern of a bright portion of the G1 image at a position of the second transmission type grating 32. That is, when the distance from the X-ray focal point 18b to the first transmission type grating 31 is L₁, and the distance from the first transmission type grating 31 to the second transmission type grating 32 is L₂, the grating pitch p₂ is determined so as to satisfy the relationship of the following expression (1).

$$\begin{matrix}[ Expression 1 ] & \\ {p}_{2} = \frac{{L}_{1} + {L}_{2}}{{L}_{1}} {p}_{1} & ( 1 )\end{matrix}$$

Each first grating piece 31A constituting the first transmission type grating 31 and each second grating piece 32A constituting the second transmission type grating 32 satisfy the expression (1) for the grating pitch and the gap. The length q₁ of a side in the x direction of the first grating piece 31A and the length q₂ of a side in the x direction of the second grating piece 32A satisfy the following expression (2), and the length r₁ of a side in the y direction of the first grating piece 31A and the length r₂ of a side in the y direction of the second grating piece 32A satisfy the following expression (3).

$$\begin{matrix}[ Expression 2 ] & \\ {q}_{2} = \frac{{L}_{1} + {l}_{2}}{{L}_{1}} {q}_{1} & ( 2 ) \\ [ Expression 3 ] & \\ {r}_{2} = \frac{{L}_{1} + {L}_{2}}{{L}_{1}} {r}_{1} & ( 3 )\end{matrix}$$

That is, with regard to the geometric shape excluding the thickness and the gap, the first grating piece 31A and the second grating piece 32A have similarity according to the ratio (L₁/(L₁+L₂)) of the distances of the first transmission type grating 31 and the second transmission type grating 32 from the X-ray focal point 18b.

In the Talbot interferometer, the distance L₂ from the first transmission type grating 31 to the second transmission type grating 32 is restricted by the Talbot interference distance determined by the grating pitch of the first diffraction grating and the X-ray wavelength. In the imaging unit 12 of the X-ray imaging system 10, however, the first transmission type grating 31 has a structure in which incident X-rays are projected without being diffracted and a GI image of the first transmission type grating 31 is similarly obtained at all positions behind the first transmission type grating 31. Accordingly, the distance L₂ can be set regardless of the Talbot interference distance.

Although the imaging unit 12 is not a constituent component of the Talbot interferometer as described above, a Talbot interference distance Z when it is assumed that X-rays are diffracted at the first transmission type grating 31 is expressed by the following expression (4) using the grating pitch p₁ of the first transmission type grating 31, the grating pitch p₂ of the second transmission type grating 32, the X-ray wavelength (peak wavelength) λ, and the positive integer m.

$$\begin{matrix}[ Expression 4 ] & \\ Z = m \frac{{p}_{1} {p}_{2}}{λ} & ( 4 )\end{matrix}$$

Expression (4) is an expression indicating the Talbot interference distance when X-rays emitted from the X-ray source 11 are cone beams, and is known from “Atsushi Momose, et al., Japanese Journal of Applied Physics, Vol. 47, and No. 10, October, 2008, pp. 8077”.

In the X-ray imaging system 10, the distance L₂ is set to a value shorter than the minimum Talbot interference distance Z when m is 1 in order to make the imaging unit 12 thin. That is, the distance L₂ is set as a value in a range which satisfies the following expression (5).

$$\begin{matrix}[ Expression 5 ] & \\ {L}_{2} < \frac{{p}_{1} {p}_{2}}{λ} & ( 5 )\end{matrix}$$

In addition, the Talbot interference distance Z when X-rays emitted from the X-ray source 11 can be substantially regarded as parallel beams is expressed by the following expression (6), and the distance L₂ is set to a value in a range which satisfies the following expression (7).

$$\begin{matrix}[ Expression 6 ] & \\ Z = m \frac{{p}_{1}^{2}}{λ} & ( 6 ) \\ [ Expression 7 ] & \\ {L}_{2} \leq \frac{{p}_{1}^{2}}{λ} & ( 7 )\end{matrix}$$

In order to generate a periodic pattern image with high contrast, it is preferable that the X-ray blocking sections 31b and 32b block (absorb) X-rays completely. However, even if the above-described materials (gold, platinum, and the like) with excellent X-ray absorption properties are used, there are quite a few X-rays transmitted through the X-ray blocking sections 31b and 32b without being absorbed. For this reason, in order to improve the X-ray blocking ability, it is preferable to set the thicknesses h1 and h2 of the X-ray blocking sections 31b and 32b as large as possible. For example, when the tube voltage of the X-ray tube 18 is 50 kV, it is preferable to block 90% or more of emitted X-rays. In this case, the thicknesses h1 and h2 are 30 μm or more in the case of gold (Au).

On the other hand, if the thicknesses h₁ and h₂ of the X-ray blocking sections 31b and 32b are set too large, it is difficult for X-rays obliquely incident on the first and second transmission type gratings 31 and 32 to pass through a slit section. As a result, since shade occurs, there is a problem in that an effective field of view in a direction (x direction) perpendicular to the extending direction (strip direction) of the X-ray blocking sections 31b and 32b becomes narrow. Therefore, the upper limits of the thicknesses h₁ and h₂ are specified in terms of ensuring the field of view. In order to ensure the length V of the effective field of view in the x direction on the detection surface of the FPD 30, assuming that the distance from the X-ray focal point 18b to the detection surface of the FPD 30 is L, the thicknesses h₁ and h₂ need to be set to satisfy the following expressions (8) and (9) from the geometrical relationship shown in FIG. 5.

$$\begin{matrix}[ Expression 8 ] & \\ {h}_{1} \leq \frac{L}{V / 2} {d}_{1} & ( 8 ) \\ [ Expression 9 ] & \\ {h}_{2} \leq \frac{L}{V / 2} {d}_{2} & ( 9 )\end{matrix}$$

For example, in the case where d₁=2.5 μm and d₂=3.0 μm and L=2 m in consideration of a normal examination at the hospital, it is preferable that the thickness h₁ is set to 100 μm or less and the thickness h₂ is set to 120 μm or less in order to ensure the length of 10 cm as the length V of the effective field of view in the x direction.

In the first and second transmission type gratings 31 and 32 configured as described above, an intensity-modulated image is formed by superposition of the G1 image of the first transmission type grating 31 and the second transmission type grating 32 and is then imaged by the FPD 30. There is a slight difference between a pattern period p₁′ of the G1 image at the position of the second transmission type grating 32 and a substantial grating pitch p₂′ (substantial pitch after manufacturing) of the second transmission type grating 32 due to a manufacturing error or an arrangement error. The arrangement error means that a substantial pitch in the x direction changes due to relative inclination or rotation of the first and second transmission type gratings 31 and 32 or change in the distance therebetween.

By the slight difference between the pattern period p₁′ of the G1 image and the grating pitch p₂′, the image contrast becomes moiré fringes. A period T of the moiré fringes is expressed by the following expression (10).

$$\begin{matrix}[ Expression 10 ] & \\ T = \frac{p {1}^{′} \times p {2}^{′}}{\vert p {1}^{′} - p {2}^{′} \vert} & ( 10 )\end{matrix}$$

In order to detect the moiré fringes with the FPD 30, it is preferable that the array pitch P of the pixels 40 in the x direction should satisfy at least the following expression (11) and further satisfies the following expression (12) (here, n is a positive integer).

[Expression 11]

p≠nT (11)

[Expression 12]

P<T (12)

Expression (11) means that the array pitch P is not an integral multiple of the moiré period T, and moiré fringes can be detected theoretically even in the case of n≧2. Expression (12) means setting the array pitch P to be smaller than the moiré period T.

The array pitch P of the pixels 40 of the FPD 30 is a value (normally about 100 μm) determined by design and is difficult to change. Accordingly, in order to adjust the size relationship between the array pitch P and the moiré period T, it is preferable to change the moiré period T by changing at least one of the pattern period p₁′ of the G1 image and the grating pitch p₂′ through positional adjustment of the first and second transmission type gratings 31 and 32.

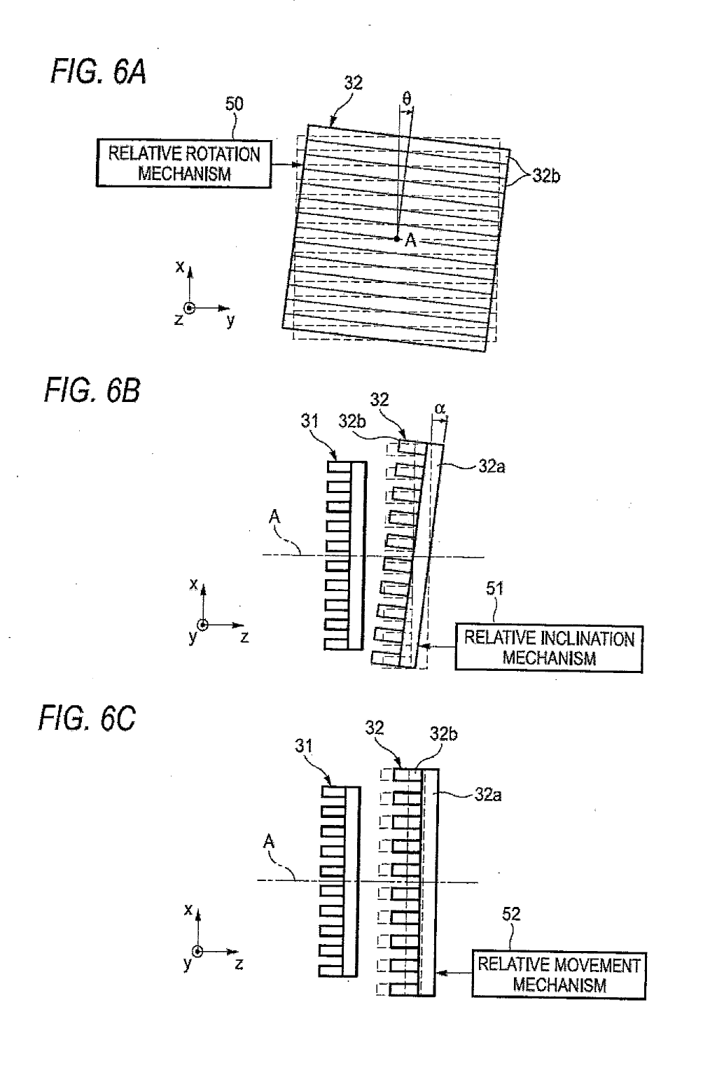

FIGS. 6A to 6C show methods of changing the moiré period T. The change of the moiré period T can be made by rotating one of the first and second transmission type gratings 31 and 32 relative to the other one with the optical axis A as the center. For example, a relative rotation mechanism 50 which rotates the second transmission type grating 32 relative to the first transmission type grating 31 with the optical axis A as the center is provided. If the second transmission type grating 32 is rotated by an angle θ by the relative rotation mechanism 50, the substantial grating pitch in the X-direction changes from p₂′ to p₂′/cos θ and as a result, the moiré period T changes (FIG. 6A).

As another example, the change of the moiré period T can be made by inclining one of the first and second transmission type gratings 31 and 32 relative to the other one with an axis, which is perpendicular to the optical axis A and positioned along the y direction, as the center. For example, a relative inclination mechanism 51 which inclines the second transmission type grating 32 relative to the first transmission type grating 31 with an axis, which is perpendicular to the optical axis A and positioned along the y direction, as the center is provided. If the second transmission type grating 32 is inclined by an angle α by the relative inclination mechanism 51, the substantial grating pitch in the X-direction changes from p₂′ to p₂′×cos α and as a result, the moiré period T changes (FIG. 6B).

As still another example, the change of the moiré period T can be made by moving one of the first and second transmission type gratings 31 and 32 relative to the other one along the direction of the optical axis A. For example, a relative movement mechanism 52 which moves the second transmission type grating 32 relative to the first transmission type grating 31 along the direction of the optical axis A so that the distance L₂ between the first and second transmission type gratings 31 and 32 is changed is provided. If the second transmission type grating 32 is moved by the amount of movement 5 along the direction of the optical axis A by the relative movement mechanism 52, the pattern period of the G1 image of the first transmission type grating 31 projected on the position of the second transmission type grating 32 changes from p₁′ to p₁′×(L₁+L₂+δ)/(L₁+L₂) and as a result, the moiré period T changes (FIG. 6C).

In this X-ray imaging system 10, the imaging unit 12 is not a Talbot interferometer as described above and the distance L₂ can be freely set. Accordingly, it is possible to appropriately adopt a mechanism which changes the moiré period T by change of the distance L₂ like the relative movement mechanism 52. The above-described change mechanisms (the relative rotation mechanism 50, the relative inclination mechanism 51, and the relative movement mechanism 52) of the first and second transmission type gratings 31 and 32 for changing the moiré period T are formed by actuators, such as a piezoelectric element.

When the subject H is disposed between the X-ray source 11 and the first transmission type grating 31, moiré fringes detected by the FPD 30 are modulated by the subject H. The amount of modulation is proportional to an angle of an X-ray deflected by the refraction effect at the subject H. Therefore, a phase contrast image of the subject H can be generated by analyzing the moiré fringes detected by the FPD 30.

Next, a method of analyzing moiré fringes will be described.

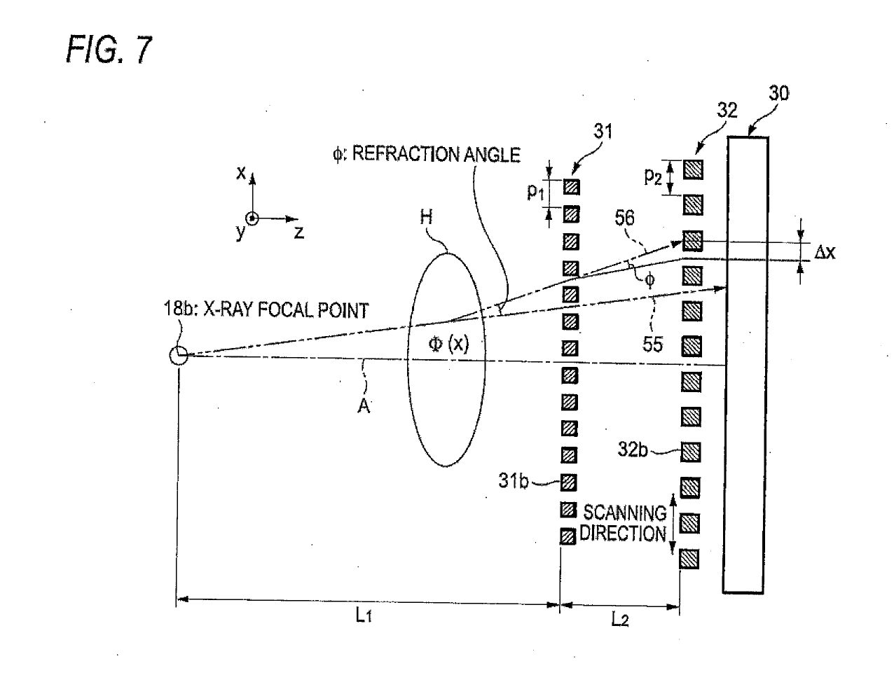

FIG. 7 shows one X-ray refracted according to the phase shift distribution Φ(x) of the subject H in the x direction. Reference numeral 55 indicates the path of an X-ray going straight when there is no subject H. The X-ray going along the path 55 passes through the first and second transmission type gratings 31 and 32 and is then incident on the FPD 30. Reference numeral 56 indicates the path of an X-ray deflected by refraction at the subject H when the subject H exists. The X-ray going along the path 56 passes through the first transmission type grating 31 and is then blocked by the second transmission type grating 32.

The phase shift distribution Φ(x) of the subject His expressed by the following expression (13) assuming that the refractive index distribution of the subject H is n(x, z) and z is a direction in which X-rays move.

$$\begin{matrix}[ Expression 13 ] & \\ Φ ( x ) = \frac{2 π}{λ} \int [ 1 - n ( x , z ) ] d x & ( 13 )\end{matrix}$$

A G1 image projected from the first transmission type grating 31 onto the position of the second transmission type grating 32 is displaced in the x direction by the amount corresponding to the refraction angle φ due to refraction of X-rays at the subject H. This amount of displacement Δx is approximately expressed by the following expression (14) on the basis of a fact that the refraction angle φ of X-rays is small.

[Expression 14]

Δx≈L₂φ (14)

Here, the refraction angle φ is expressed by the following expression (15) using the X-ray wavelength λ and the phase shift distribution Φ(x) of the subject H.

$$\begin{matrix}[ Expression 15 ] & \\ ϕ = \frac{λ}{2 π} \frac{\partial Φ ( x )}{\partial x} & ( 15 )\end{matrix}$$

Thus, the amount of displacement Δx of the G1 image by refraction of X-rays at the subject H is associated with the phase shift distribution Φ(x) of the subject H. In addition, the amount of displacement Δx is related, like the following expression (16), with the amount of phase shift ψ of a signal (amount of phase shift of a signal of each pixel 40 in each of the cases when there is the subject H and when there is no subject H) output from each pixel 40 of the FPD 30.

$$\begin{matrix}[ Expression 16 ] & \\ Ψ = \frac{2 π}{{p}_{2}} Δ x = \frac{2 π}{{p}_{2}} {L}_{2} ϕ & ( 16 )\end{matrix}$$

Accordingly, by calculating the amount of phase shift ψ of the signal of each pixel 40, the refraction angle φ is calculated from expression (16). In addition, the differential amount of the phase shift distribution Φ(x) is calculated using expression (15). By integrating this for x, the phase shift distribution Φ(x) of the subject H may be generated. A phase contrast images of the subject H can be generated with use of the amount of phase shift ψ, the refraction angle φ and the shapes shift distribution Φ(x). In the X-ray imaging system 10, the amount of phase shift ψ is calculated using a fringe scanning method shown below.

In the fringe scanning method, imaging is performed while performing translational movement of one of the first and second transmission type gratings 31 and 32 relative to the other one in a stepwise manner in the x direction (that is, imaging is performed while changing the phases of lattice periods of both the first and second transmission type gratings 31 and 32). Although the second transmission type grating 32 is moved by the scanning mechanism 33 in the X-ray imaging system 10, the first transmission type grating 31 may be moved. When moiré fringes move according to the movement of the second transmission type grating 32 and the distance of translational movement (amount of movement in the x direction) amounts to one period (grating pitch p₂) of the lattice period of the second transmission type grating 32 (that is, when a phase change amounts to 2π), the moiré fringes return to the original positions. By capturing fringe images according to such a change of moiré fringes by the FPD 30 while moving the second transmission type grating 32 gradually by the amount obtained by dividing the grating pitch p₂ by an integer, acquiring a signal of each pixel 40 from the plurality of captured fringe images, and performing arithmetic processing by the arithmetic processing section 22, the amount of phase shift ψ of the signal of each pixel 40 is acquired.

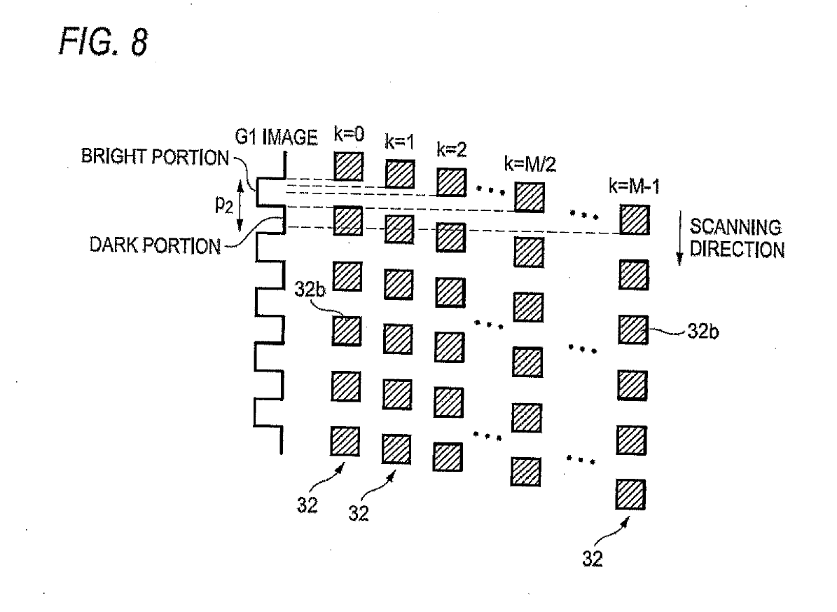

FIG. 8 is a schematic view showing a state where the second transmission type grating 32 is gradually moved by a scanning pitch (p₂/M) obtained by dividing the grating pitch p₂ by M (integers of 2 or more). The scanning mechanism 33 performs translational movement of the second transmission type grating 32 sequentially at M scanning positions (k=0, 1, 2, . . . , M−1). In FIG. 8, the initial position of the second transmission type grating 32 is set as a position (k=0) at which a dark portion of a G1 image at the position of the second transmission type grating 32 when there is no subject H almost matches the X-ray blocking sections 32b. However, the initial position may be any of the M scanning positions (k=0, 1, 2, . . . , M−1).

First, at a position of k=0, X-rays which are not refracted by the subject H mainly pass through the second transmission type grating 32. Next, if the second transmission type grating 32 is moved in order of k=1, 2, . . . , with regard to X-rays which pass through the second transmission type grating 32, the components of X-rays which are not refracted by the subject decrease, and the components of X-rays which are refracted by the subject increase. In particular, when k=M/2, only X-rays which are refracted by the subject H mainly pass through the second transmission type grating 32. If k exceeds M/2, to the contrary, with regard to X-rays which pass through the second transmission type grating 32, the components of X-rays which are refracted by the subject H decrease, and the components of X-rays which are not refracted by the subject H increase.

If imaging is carried out by the FPD 30 at each position of k=0, 1, 2, . . . , M−1, M signal values are obtained for each pixel 40. Hereinafter, a method will be described which calculates the amount of phase shift ψ of a signal of each pixel from the M signal values. If the signal of each pixel 40 at the position k of the second transmission type grating 32 is denoted by Iₖ(x), Iₖ(x) is expressed by the following expression (17).

$$\begin{matrix}[ Expression 17 ] & \\ {I}_{k} ( x ) = {A}_{0} + {\sum }_{n > 0}^{ } {A}_{n} exp [ 2 π i \frac{n}{{p}_{2}} \{ {L}_{2} ϕ ( x ) + \frac{{kp}_{2}}{M} \} ] & ( 17 )\end{matrix}$$

Here, x is a coordinate regarding the x direction of the pixel 40, A₀ is the intensity of incident X-rays, and Aₙ is a value corresponding to contrast of a signal value of the pixel 40 (where n is a positive integer). φ(x) is the refraction angle φ represented by the function of the coordinate x of the pixel 40.

Next, if the relational expression of the following expression (18) is used, the refraction angle φp(x) is expressed by the following expression (19).

$$\begin{matrix}[ Expression 18 ] & \\ {\sum }_{k = 0}^{M - 1} exp ( - 2 π i \frac{k}{M} ) = 0 & ( 18 ) \\ [ Expression 19 ] & \\ ϕ ( x ) = \frac{{p}_{2}}{2 π {L}_{2}} arg [ {\sum }_{k = 0}^{M - 1} {I}_{k} ( x ) exp ( - 2 πi \frac{k}{M} ) ] & ( 19 )\end{matrix}$$

Here, arg[] means calculation of an angle of deviation and corresponds to the amount of phase shift ψ of an intensity-modulated signal of each pixel 40. Thus, the amount of phase shift ψ of a signal of each pixel 40 is calculated from the M signal value obtained in each pixel 40 on the basis of the expression (19), thereby obtaining the refraction angle φ(x).

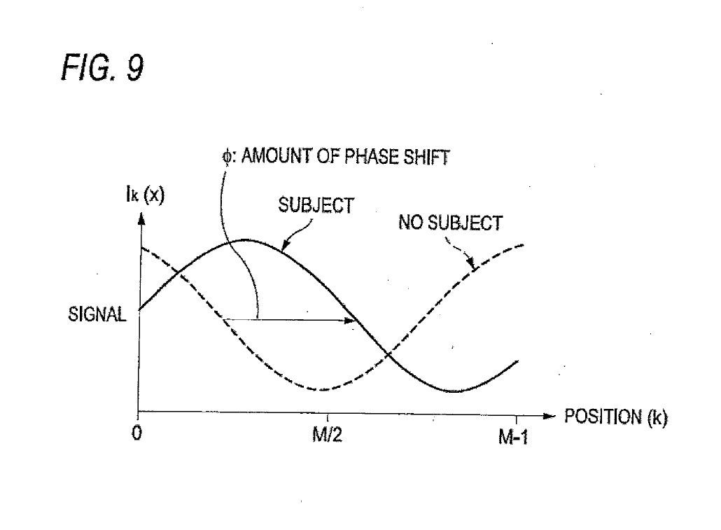

Specifically, as shown in FIG. 9, the M signal values obtained in each pixel 40 are periodically changed in the period of the grating piece p₂ with respect to the position k of the second transmission type grating 32. In the drawing, a broken line indicates a variation in the signal value when the subject H is absent, and a solid line indicates a variation in the signal value when the subject H is present. The phase difference between the Waveforms of both variations corresponds to the amount of phase shift ψ of a signal of each pixel 40.

As shown in the expression (15), the refraction angle φ(x) is a value corresponding to a differential phase value. For this reason, the phase shift distribution Φ(x) is obtained by integrating the refraction angle φ(x) along the x axis.

In the above description, the y coordinate regarding the y direction of the pixel 40 is not taken into consideration, with the same arithmetic operation for each y coordinate, the two-dimensional phase shift distribution Φ(x,y) in the x and y directions is obtained.

The above-described arithmetic operation is carried out by the arithmetic processing section 22. The arithmetic processing section 22 stores the phase shift distribution Φ(x,y) as a phase contrast image in the storage section 23. The phase shift distribution Φ(x,y) is obtained by integrating the differential amount of the phase shift distribution obtained from the refraction angle φ, and the refraction angle φ and the phase shift distribution Φ are also associated with a variation in the phase of X-rays by the subject. Thus, the differential amount of the refraction angle φ or the phase shift distribution Φ may be set as a phase contrast image.

The above-described fringe scanning and the processing for generating the phase contrast image are automatically performed through the linkage operation of the respective sections under the control of the control device 20 after an imaging instruction of the operator is issued from the input device 21, and the phase contrast image of the subject H is finally displayed on the monitor 24.

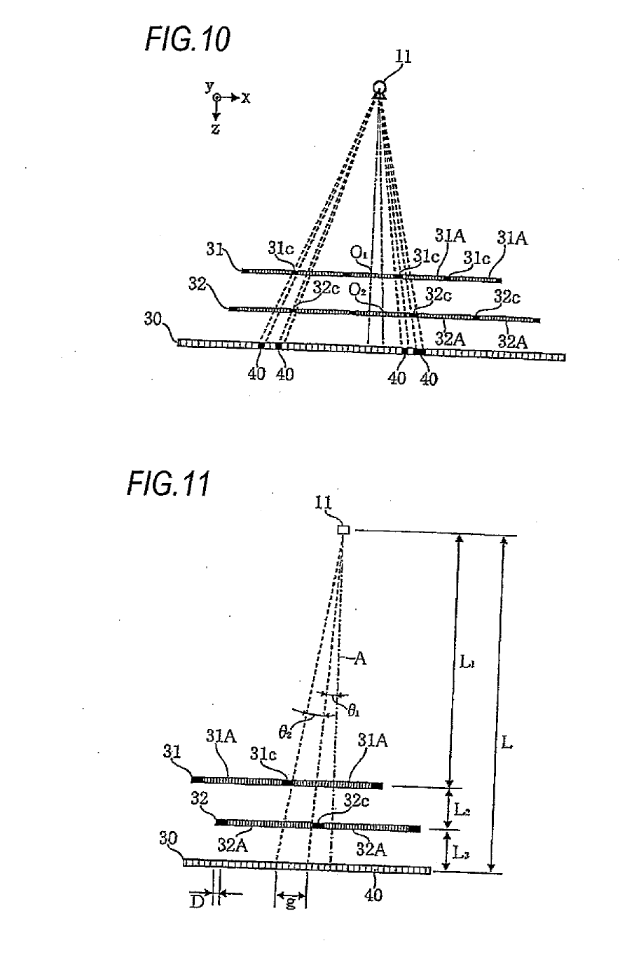

FIG. 10 schematically shows the arrangement of the first and second transmission type gratings 31 and 32. As described above, in the X-ray imaging system, the first transmission type grating 32 is constituted by connecting a plurality of first grating pieces 31A, and the second transmission type grating 32 is also constituted by connecting a plurality of second grating pieces 32A. With regard to the geometric shape excluding the thickness and gap, the first grating pieces 31A and the second grating pieces 32A have similarity according to the ratio of the distances of the first transmission type grating 31 and the second transmission type grating 32 from the focus of the X-ray source 11.

The arrangement of a plurality of second grating pieces 32A in the second transmission type grating 32 is the same as the arrangement of a plurality of first grating pieces 31A in the first transmission type grating 31. In the example of the drawing, the first transmission type grating 31 is constituted such that a plurality of first grating pieces 31A are arranged in a column shape, and the second grating pieces 32A are arranged in a column shape by the number of a plurality of first grating pieces 31A constituting the first transmission type grating 31. The arrangement direction of a plurality of first grating pieces 31A and the arrangement direction of a plurality of second grating pieces 32A follow the x direction which is the scanning direction of the second transmission type grating 32 in the fringe scanning. The arrangement direction of a plurality of first grating pieces 31A and the arrangement direction of a plurality of second grating pieces 32A may not be strictly aligned with each other. For example, the second transmission type grating 32 may be rotated relatively around the optical axis A with respect to the first transmission type grating 31 by the above-described relative rotation mechanism (see FIG. 6A), such that the arrangement direction of a plurality of first grating pieces 31A and the arrangement direction of a plurality of second grating pieces 32A may be slightly misaligned.

The first and second transmission type gratings 31 and 32 configured as above are arranged such that, in projection onto the FPD 30 with the focus of the X-ray source 11 as a viewpoint, the projection positions of the centers O₁ and O₂ thereof are misaligned in the x direction, that is, in the arrangement direction of a plurality of grating pieces in the first transmission type grating 31 or the second transmission type grating 32. Thus, at least one pixel (a pixel which belongs to a third pixel group) is interposed between each pixel 40 (each pixel which belongs to a first pixel group) onto which a connection portion 31c of two adjacent first grating pieces 31A is projected and each pixel 40 (each pixel which belongs to a second pixel group) onto which a connection portion 32c of two adjacent second grating pieces 32A is projected. In other words, a gap which is greater than the pixel pitch in the FPD 30 is placed between projection of the connection portion 31c and projection of the connection portion 32c.

FIG. 11 shows the arrangement of the first and second transmission type gratings 31 and 32 in detail. In projection onto the image receiving surface of the FPD 30 with the focus of the X-ray source 11 as a viewpoint, the gap g between projection of the connection portion 31c of two adjacent first grating pieces 31A and projection of the connection portion 32c of two adjacent second grating pieces 32A is expressed by the following expression (20).

[Expression 20]

g=L{tan(θ₁+θ₂)−tan θ₁} (20)

Here, L represents the distance between the X-ray source 11 and the FPD 30, θ₁ represents the angle between a line segment, which connects one of the connection portion 31c and the connection portion 32c closer to the optical axis A and the X-ray source 11, and the optical axis A, and θ₂ represents the angle between a line segment which connects the connection portion 31c and the X-ray source 11 and a line segment which connects the connection portion 32c and the X-ray source 11.

If the gap g is greater than the pixel pitch D in the FPD 30, at least one pixel 40 is interposed between each pixel 40 onto which the connection portion 31c is projected and each pixel 40 onto which the connection portion 32c is projected. The condition that the line segment which connects the connection portion 31c and the X-ray source 11 and the line segment which connects the connection portion 32c and the X-ray source 11 should satisfy is expressed by the following expression (21).

$$\begin{matrix}[ Expression 21 ] & \\ {θ}_{2} \geq arctan \{ \frac{D}{L} + tan {θ}_{1} \} - {θ}_{1} & ( 21 )\end{matrix}$$

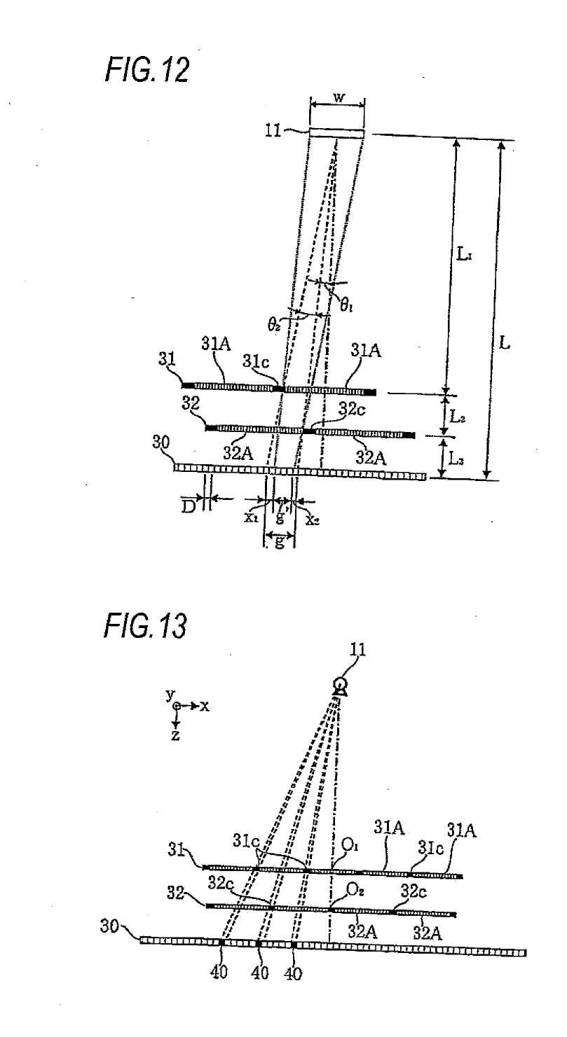

The above description shows a case where it is assumed that the X-ray source 11 is a point light source, and when the X-ray source 11 has a width w in the connection direction of a plurality of first grating pieces 31A or second grating pieces 32A, as shown in FIG. 12, blurring occurs at the edge of projection of the connection portions 31c and 32c and projection is expanded. In the drawing, x₁ represents the expansion amount of projection of the connection portion 31 c toward the connection portion 32c, and x₂ represents the expansion amount of projection of the connection portion 32c toward the connection portion 31c. Geometrically, the expansion amount x₁ of projection of the connection portion 31c is expressed by the following expression (22), and the expansion amount x₂ of projection of the connection portion 32c is expressed by the following expression (22).

$$\begin{matrix}[ Expression 22 ] & \\ {x}_{1} = \frac{1}{2} w \frac{{L}_{2} + {L}_{3}}{{L}_{1}} & ( 22 ) \\ [ Expression 23 ] & \\ {x}_{2} = \frac{1}{2} w \frac{{L}_{3}}{{L}_{1} + {L}_{2}} & ( 23 )\end{matrix}$$

Here, L₁ represents the distance between the X-ray source 11 and the first transmission type grating 31, L₂ represents the distance between the first transmission type grating 31 and the second transmission type grating 32, and L₃ represents the distance between the second transmission type grating 32 and the FPD 30.

Thus, the gap g′ between projection of the connection portion 31c and projection of the connection portion 32c is expressed by the following expression (24).

$$\begin{matrix}[ Expression 24 ] & \\ {g}^{′} = g - {x}_{1} - {x}_{2} = L \{ tan ( {θ}_{1} + {θ}_{2} ) - tan {θ}_{1} \} - \frac{1}{2} w ( \frac{{L}_{2} + {L}_{3}}{{L}_{1}} + \frac{{L}_{3}}{{L}_{1} + {L}_{2}} ) & ( 24 )\end{matrix}$$

If the gap g′ is greater than the pixel pitch D in the FPD 30, at least one pixel 40 is interposed between each pixel 40 onto which the connection portion 31c is projected and each pixel 40 onto which the connection portion 32c is projected. Thus, the condition that the line segment which connects the connection portion 31c and the X-ray source 11 and the line segment which connects the connection portion 32c and the X-ray source 11 should satisfy is expressed by the following expression (25).

$$\begin{matrix}[ Expression 25 ] & \\ {θ}_{2} \geq arctan [ \frac{1}{L} \{ D + \frac{w}{2} ( \frac{{L}_{2} + {L}_{3}}{{L}_{1}} + \frac{{L}_{3}}{{L}_{1} + {L}_{2}} ) \} - tan {θ}_{1} ] - {θ}_{1} & ( 25 )\end{matrix}$$

With the above, at least one pixel 40 can be interposed between each pixel 40 onto which the connection portion 31c is projected and each pixel 40 onto which the connection portion 32c is projected.

In the connection portions 31c and 32c, normal fringe scanning is not performed, such that with regard to each pixel 40 onto which each of the connection portions 31c and 32c is projected, interpolation is made on the basis of the output signals of peripheral pixels 40. In the interpolation, the output signal of a pixel 40 which is interposed between each pixel 40 onto which the connection portion 31c is projected and each pixel 40 onto which the connection portion 32c is projected, and closest to each pixel onto which each of the connection portions 31c and 32c is projected can be used.

According to the above-described X-ray imaging system 10, the first transmission type grating 31 is constituted by a plurality of first grating pieces 31A, and the second transmission type grating 32 is constituted by a plurality of second grating pieces 32A, such that an radiation exposure field can be easily expanded.

According to the above-described X-ray imaging system 10, at least one pixel 40 is interposed between each pixel 40 onto which the connection portion 31c of two adjacent first grating pieces 31A is projected and each pixel 40 onto which the connection portion 32c of two adjacent second grating pieces 32A is projected. Thus, the pixel 40 in which the phase information of X-rays can be obtained can be provided to be closest to the pixel 40 onto which each of the connection portions 31c and 32c is projected. Therefore, the phase information of X-rays in each pixel 40 onto which each of the connection portions 31c and 32c is projected can be accurately interpolated by using the phase information of X-rays in the closest pixel 40, and image quality can be maintained.

According to the above-described X-ray imaging system 10, with regard to exposure X-rays, high spatial coherence is not required such that the X-rays are geometrically projected onto the second transmission type grating 32 while being scarcely diffracted in the first transmission type grating 31, and a general X-ray source which is used in the medical field can be used as the X-ray source. The distance L₂ from the first transmission type grating 31 to the second transmission type grating 32 can be set to an arbitrary value, and the distance L₂ can be set to be smaller than the minimum Talbot interference distance in the Talbot interferometer, making it possible to reduce the size (thickness) of the imaging unit 12. According to the X-ray imaging system 10, all the wavelength components of the exposure X-rays substantially contribute to the projection image (G1 image) from the first transmission type grating 31, and the contrast of a moire fringe can be improved, making it possible to improve the detection sensitivity of the phase contrast image.

The above-described X-ray imaging system performs fringe scanning on the projection image of the first transmission type grating 31 to calculate the refraction angle cp. For this reason, a case has been described where the first and second transmission type gratings 31 and 32 are all absorption type gratings. However, the invention is not limited thereto. The invention may be useful when fringe scanning is performed on a Talbot interference image to calculate the refraction angle φ, as described above. Therefore, the first transmission type grating 31 is not limited to an absorption type grating and may be a phase type grating.

Although in the above-described X-ray imaging system 10, a case has been described where a moire fringe which is formed when the projection image of the first transmission type grating 31 overlaps the second transmission type grating 32 is analyzed by the fringe scanning method, the analysis method of a moire fringe is not limited, to the fringe scanning method. For example, various methods using a moire fringe, such as a method using Fourier transform/inverse Fourier transform described in “J. Opt. Soc. Am. vol. 72, No. 1 (1982) p. 156”, may be applied.

Hereinafter, the analysis method of a moire fringe using Fourier transform/inverse Fourier transform will be described. A moire fringe which is formed by the first and second transmission type gratings 31 and 32 with the X-ray blocking sections 31b and 32b extending in the y direction can be expressed by the following expression (26), and the expression (26) can be rewritten as the following expression (27).

[Expression 26]

I(x, y)=a(x, y)+b(x, y)cos(2πf₀x+φ(x, y)) (26)

[Expression 27]

I(x, y)=a(x, y)+c(x, y) exp(2πf₀x)+c*(x, y) exp(−2πf₀x) (27)

In expression (26), a(x, y) indicates a background, b(x, y) indicates an amplitude of a basic frequency component of a moiré, and f₀ indicates a basic frequency of a moiré. Moreover, in expression (27), c(x, y) is expressed by the following expression (28).

$$\begin{matrix}[ Expression 28 ] & \\ c ( x , y ) = \frac{1}{2} b ( x , y ) exp [ i ϕ ( x , y ) ] & ( 28 )\end{matrix}$$

Accordingly, the information regarding the refraction angle φ(x, y) can be acquired by extracting components of c(x, y) or c*(x, y) from the moiré fringes. Here, expression (27) becomes the following expression (29) by the Fourier transform.

[Expression 29]

I(fₓ,f_{y})=A(fₓ,f_{y})+C(fₓ−f₀,f_{y})+C*(fₓ+f₀,f_{y}) (29)

In expression (29), I(fₓ, f_{y}), A(fₓ, f_{y}), and C(fₓ, f_{y}) are two-dimensional Fourier transforms with respect to I(x, y), a(x, y), and c(x, y), respectively.

The spectrum pattern of a moire fringe usually has three peaks, and a peak derived from A(fₓ,f_{y}) is sandwiched between peaks derived from C(fₓ,f_{y}) and C*(fₓ,f_{y}). A region including the peak derived from C(fₓ,f_{y}) or C*(fₓ,f_{y}) is cut, the cut peak derived from C(fₓ,f_{y}) or C*(fₓ,f_{y}) is moved to the origin of the frequency space, and inverse Fourier transform is performed, thereby obtaining the refraction angle φ(x,y) from the resultant complex number information.

Although in the above-described X-ray imaging system, the subject H is arranged between the X-ray source 11 and the first transmission type grating 31, when the subject H is arranged between the first transmission type grating 31 and the second transmission type grating 32, the phase contrast image can be generated in the same manner.

FIG. 13 shows a modification of the above-described X-ray imaging system 10. In the example of the drawing, the first and second transmission type gratings 31 and 32 are arranged such that, in projection onto the FPD 30 with the X-ray source 11 as a viewpoint, the projection positions of the centers O₁ and O₂ thereof are substantially aligned in the x direction, that is, in the connection direction of a plurality of first grating pieces 31A in the first transmission type grating 31.

However, the arrangement of a plurality of second grating pieces 32A in the second transmission type grating 32 is different from the arrangement of a plurality of first grating pieces 31A in the first transmission type grating 31. In the example of the drawing, while the first transmission type grating 31 is constituted by five first grating pieces 31A arranged in the x direction, the second transmission type grating 32 is constituted by four second grating pieces 32A arranged in the x direction to be smaller than the number of a plurality of first grating pieces 31A constituting the first transmission type grating 31.

Even when the first and second transmission type gratings 31 and 32 configured as above are arranged such that, in projection onto the FPD 30 with the focus of the X-ray source 11 as a viewpoint, the projection positions of the centers O₁ and O₂ are substantially aligned, at least one pixel 40 can be interposed between each pixel 40 onto which the connection portion 31c of two adjacent first grating pieces 31A is projected and each pixel 40 onto which the connection portion 32c of two adjacent second grating pieces 32A.

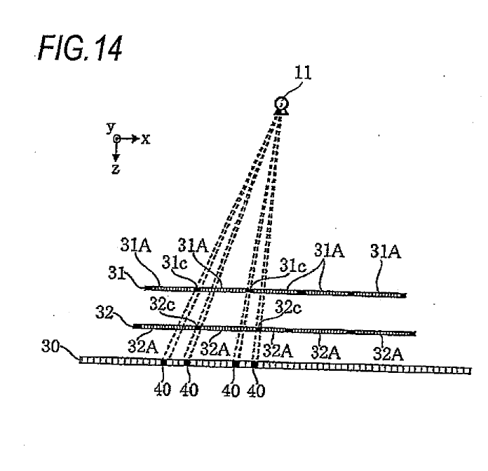

FIG. 14 shows another modification of the above-described X-ray imaging system 10. In the example of the drawing, the second transmission type grating 32 is configured such that four second grating pieces 32A which are smaller than the number of a plurality of first grating pieces 31A constituting the first transmission type grating 31 are arranged in the x direction, and a third grating piece 32B is interposed at the center of the arrangement of the second grating pieces 32A. The third grating piece 32B has a side in the y direction having the same length and thickness as the second grating pieces 32A with the same grating pitch and gap as the second grating pieces 32A, and has a side in the x direction having a length different from the second grating pieces 32A.

Even when the first and second transmission type gratings 31 and 32 configured as above are arranged such that, in projection onto the FPD 30 with the focus of the X-ray source 11 as a viewpoint, the projection positions of the center O₁ and O₂ thereof are substantially aligned, at least one pixel 40 can be interposed between each pixel 40 onto which the connection portion 31c of two adjacent first grating pieces 31A is projected and each pixel 40 onto which the connection portion 32c of two adjacent second grating pieces 32A is projected. The first transmission type grating 31 may be constituted by two types of grating pieces with sides in the x direction having different lengths.

Although the first and second transmission type gratings 31 and 32 of the above-described X-ray imaging system 10 are configured such that the periodic arrangement direction of the X-ray blocking sections 31b and 32b are linear (that is, the grating surface is a planar shape), the first and second transmission type gratings 31 and 32 may be configured to have a concave curve shape which is curved around the X-ray focal point 18b.

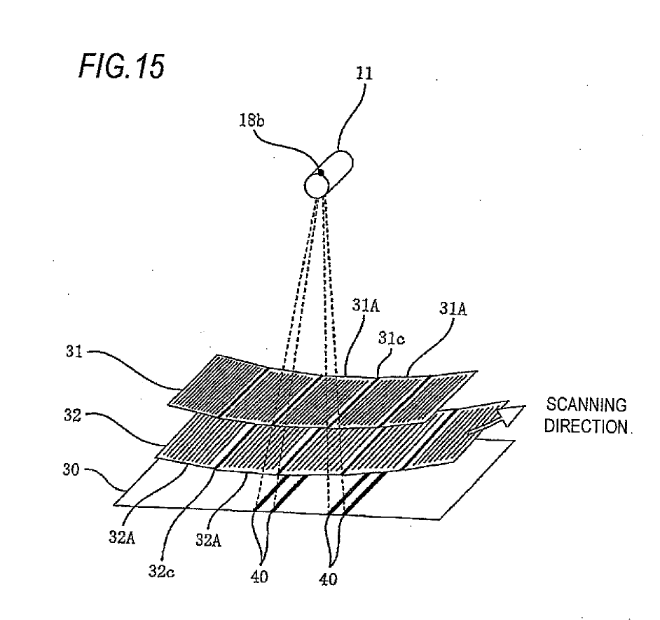

In the example of FIG. 15, the grating surface of each of the first and second transmission type gratings 31 and 32 is configured to have a concave curve shape which is curved around the X-ray focal point 18b in the cross-section along the scanning direction of fringe scanning. In the first transmission type grating 31, two adjacent first grating pieces 31A in the scanning direction are connected while being inclined at a predetermined angle. In the second transmission type grating 32, similarly, two adjacent second grating pieces 32A in the scanning direction are connected while being inclined at a predetermined angle. Thus, the grating surfaces have the concave curve shape. Thus, each of the first and second transmission type gratings 31 and 32 are constituted by connecting a plurality of grating pieces, thus the grating surfaces can easily have the concave curve shape.

The grating surface of each of the first and second transmission type gratings 31 and 32 is in the concave curve shape, such that, when the subject H is absent, the X-rays exposed from the X-ray focal point 18b are all incident substantially perpendicularly to the grating surface. Thus, the restriction in the upper limit of the thickness h₁ of the X-ray blocking sections 31b and the thickness h₂ of the X-ray blocking sections 32b, and it is not necessary to take into consideration of the expressions (8) and (9).

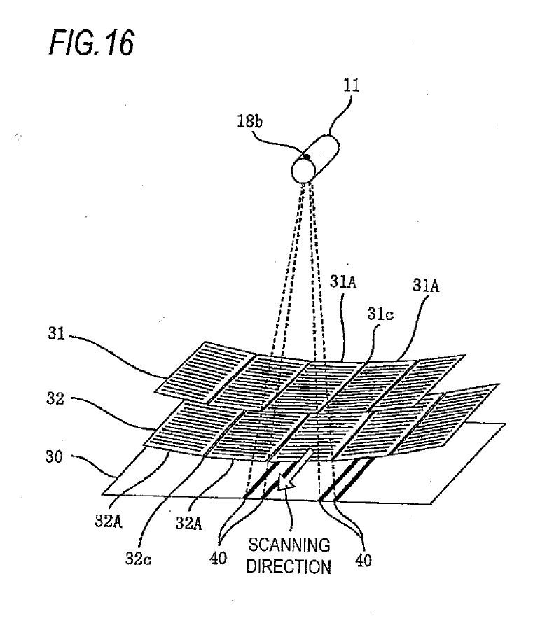

In the example of FIG. 16, the grating surface of each of the first and second transmission type gratings 31 and 32 is configured to have a concave curve shape which is curved around the X-ray focal point 18b in the cross-section perpendicular to the scanning direction of fringe scanning. In the first transmission type grating 31, two adjacent first grating pieces 31A in the direction perpendicular to the scanning direction are connected while being inclined at a predetermined angle. In the second transmission type grating 32, similarly, two adjacent second grating pieces 32A in the direction perpendicular to the scanning direction are connected while being inclined at a predetermined angle. Thus, the grating surfaces have the concave curve shape.

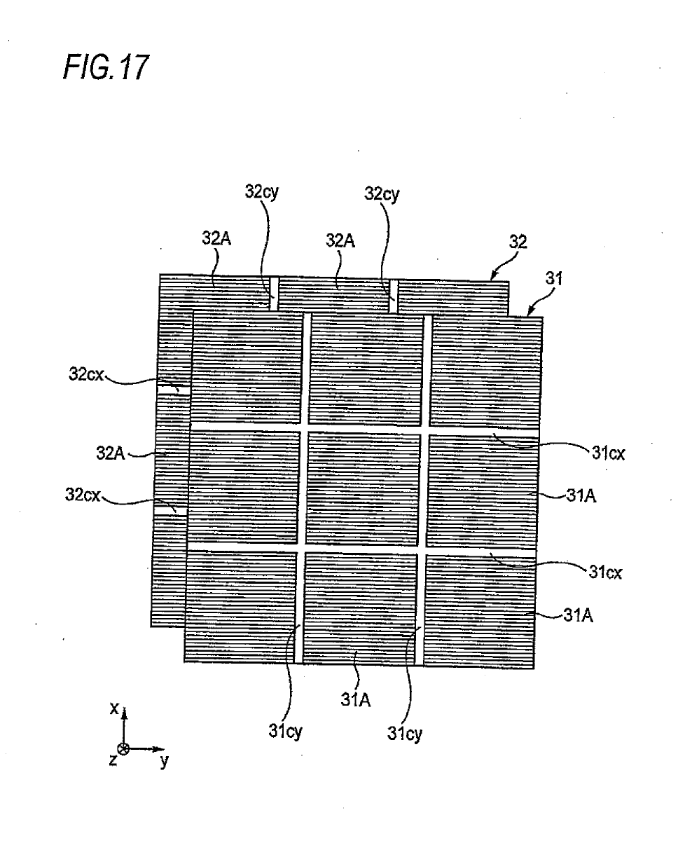

Each of the first and second transmission type gratings 31 and 32 of the above-described X-ray imaging system 10 are constituted by connecting a plurality of grating pieces in a column shape in the scanning direction (the x direction) of fringe scanning. Meanwhile, as shown in FIG. 17, a plurality of first grating pieces 31A may be arranged in a matrix to constitute the first transmission type grating 31, and a plurality of second grating pieces 32A may be arranged in a matrix to constituted the second transmission type grating 32.

In the example of the drawing, one arrangement direction of a plurality of first grating pieces 31A in the first transmission type grating 31 substantially follows the x direction which is the scanning direction of the second transmission type grating 32 for fringe scanning, and the other arrangement direction of a plurality of first grating pieces 31A substantially follows the y direction. One arrangement direction of a plurality of second grating pieces 32A in the second transmission type grating 31 substantially follows the x direction, and the other arrangement direction of a plurality of second grating pieces 32A substantially follows the y direction. In the geometric shape excluding the thickness and gap, the first grating pieces 31A and the second grating pieces 32A have similarity according to the ratio of the distances of the first transmission type grating 31 and the second transmission type grating 32 from the X-ray source 11. The first grating pieces 31A and the second grating pieces 32A have the same arrangement (the number of first grating pieces 31A and the number of second grating pieces 32A arranged in the x direction are the same, and the number of first grating pieces 31A and the number of second grating pieces 32A arranged in the y direction are the same).

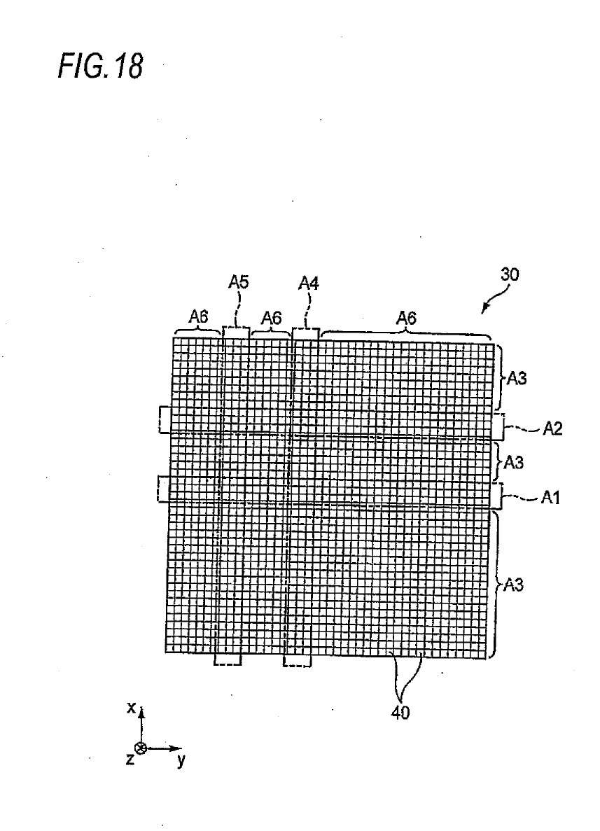

In projection onto the FPD 30 with the X-ray source 11 as a viewpoint, the first and second transmission type gratings 31 and 32 are arranged such that the projection positions of the centers thereof are misaligned in the x and y directions. Thus, as shown in FIG. 18, at least one pixel (a pixel which belongs to a third pixel group A3) 40 is interposed between each pixel (each pixel which belongs to a first pixel group A1) 40 onto which a connection portion 31cₓ of two adjacent first grating pieces 31A in the x direction is projected and each pixel (each pixel which belongs to a second pixel group A2) 40 onto which a connection portion 32cₓ of two adjacent second grating pieces 32A in the x direction is projected in the same manner. At least one pixel (a pixel which belongs to a sixth pixel group A6) 40 is interposed between each pixel (each pixel which belongs to a fourth pixel group A4) 40 onto which a connection portion 31c_{y} of two adjacent first grating pieces 31A in the y direction is projected and each pixel (each pixel which belongs to a fifth pixel group A5) 40 onto which a connection portion 32c_{y} of two adjacent second grating pieces 32A in the y direction is projected in the same manner.

In each of the x and y directions, it is preferable that at least one pixel 40 is interposed between each pixel 40 onto which the connection portion of two adjacent first grating pieces in the corresponding direction is projected and each pixel 40 onto which the connection portion of two adjacent second grating pieces in the corresponding direction is projected. Meanwhile, in either the x direction or the y direction, at least one pixel 40 may be interposed between each pixel 40 onto which the connection portion of two adjacent first grating pieces 31A in the corresponding direction is projected and each pixel 40 onto which the connection portion of two adjacent second grating pieces 32A in the same direction is projected. In the corresponding direction, the pixel 40 in which the phase information of X-rays can be obtained can be provided to be closest to the pixels 40 onto which both connection portions are projected.

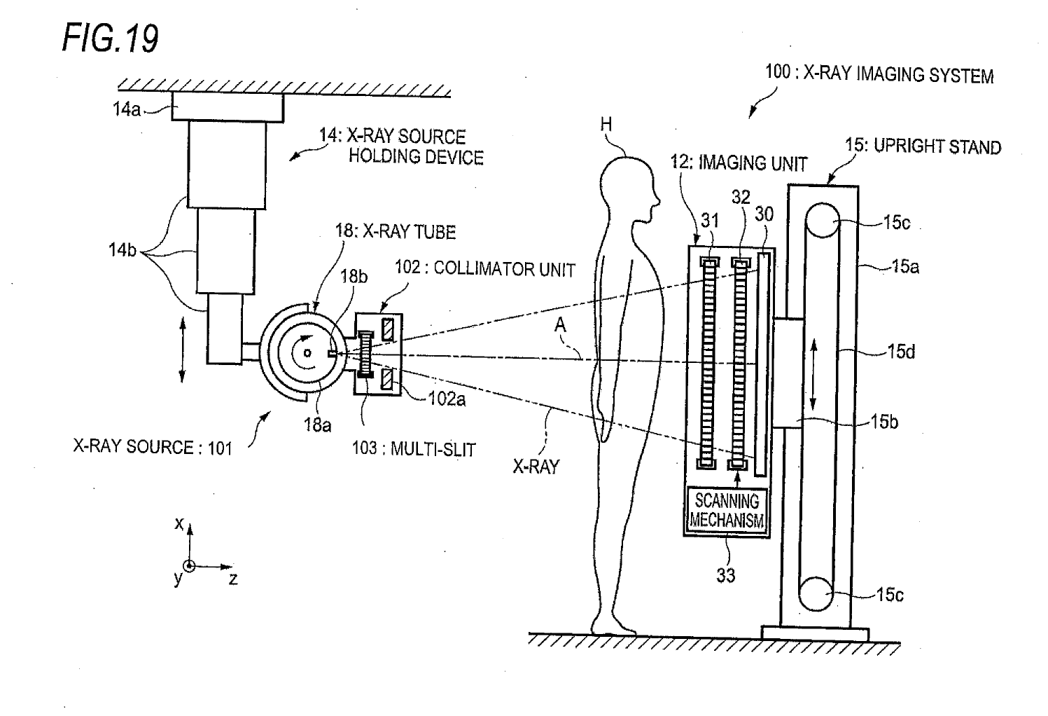

FIG. 19 shows another example of a radiographic system for illustrating an embodiment of the invention.

An X-ray imaging system 100 shown in FIG. 19 is different from the above-described X-ray imaging system 10 in that a multi slit 103 is provided in the collimator unit 102 of the X-ray source 11. Other parts are the same as those in the X-ray imaging system 10, thus description thereof will be omitted.

In the above-described X-ray imaging system, when the distance from the X-ray source 11 to the FPD 30 is set to a distance (1 m to 2 m) which is set in the general imaging room, the image quality of the phase contrast image may be degraded because of the influence of blurring of the G1 image caused by the focal size (in general, about 0.1 mm to 1 mm) of the X-ray focal point 18b. Thus, it is considered that a pinhole is provided immediately after the X-ray focal point 18b to effectively decrease the focal size. However, if the opening area of the pinhole decreases so as to reduce the effective focal size, X-ray intensity is degraded. In this X-ray imaging system 100, in order to solve this problem, the multi slit 103 is arranged immediately after the X-ray focal point 18b.

The multi slit 103 is the same transmission type grating (absorption type grating) as the first and second transmission type gratings 31 and 32 provided in the imaging unit 12, and a plurality of X-ray blocking sections extending in one direction (the y direction) are arranged periodically in the same direction (the x direction) as the X-ray blocking sections 31b and 32b of the first and second transmission type gratings 31 and 32. The multi slit 103 partially blocks radiation emitted from the X-ray focal point 18b to reduce the effective focal size in the x direction, thereby forming multiple point light sources (scattered light sources) in the x direction.

When the distance from the multi slit 103 to the first transmission type grating 31 is L₃, the grating pitch p₃ of the multi slit 103 should satisfy the following expression (30).

$$\begin{matrix}[ Expression 30 ] & \\ {p}_{3} = \frac{{L}_{3}}{{L}_{2}} {p}_{2} & ( 30 )\end{matrix}$$

The expression (30) is the geometric condition such that the projection image (G1 image) of an X-ray emitted from each point light source scattered by the multi slit 103 by the first transmission type grating 31 is aligned with (overlaps) the position of the second transmission type grating 32.

Since the position of the multi slit 103 substantially becomes the position of the X-ray focus, the grating pitch p₂ of the second transmission type grating 32 is determined so as to satisfy the relationship of the following expression (31).

$$\begin{matrix}[ Expression 31 ] & \\ {p}_{2} = \frac{{L}_{3} + {L}_{2}}{{L}_{3}} {p}_{1} & ( 31 )\end{matrix}$$

As described above, in this X-ray imaging system 100, the G1 images based on a plurality of point light sources formed by the multi slit 103 are superimposed, thereby improving the image quality of the phase contrast image without causing degradation of X-ray intensity. The above-described multi slit 103 may be applied to any X-ray imaging system described above.

Although in the above-described X-ray imaging system 10 or 100, the invention is applied to a device for medical diagnosis, the invention is not limited to the purpose of medical diagnosis, and may also be applied to other industrial radiation detection devices.

As described above, this specification describes a radiation detection device. The radiation detection device includes a first grating, a second grating which has a periodic pattern substantially the same as the periodic pattern of a radiation image of the first grating formed by radiation having passed through the first grating, and a radiation image detector which detects the radiation image masked with the second grating. Each of the first grating and the second grating includes a plurality of grating pieces which are arranged at least in a first direction within a plane crossing the traveling direction of radiation passing therethrough. In projection onto the radiation image detector with a radiation focal point as a viewpoint, the radiographic image detector includes a first pixel group onto which the connection portion of adjacent grating pieces of the first grating in the first direction is projected, a second pixel group onto which the connection portion of adjacent grating pieces of the second grating in the first direction is projected, and a third pixel group excluding the first pixel group and the second pixel group. At least one pixel which belongs to the third pixel group is interposed between each pixel which belongs to the first pixel group and each pixel which belongs to the second pixel group.

In the radiation detection device described in this specification, in projection onto the radiation image detector with the radiation focal point as a viewpoint, projection of the center of the first grating and projection of the center of the second grating are misaligned in the first direction.

In the radiation detection device described in this specification, the number of grating pieces of the first grating arranged in the first direction is different from the number of grating pieces of the second grating arranged in the first direction.

In the radiation detection device described in this specification, in at least one of the first grating and the second grating, for each column of grating pieces arranged in the first direction, the dimension of a part of the grating pieces in the first direction is different from the other grating pieces.

In the radiation detection device described in this specification, in each of the first and second gratings, a surface in which the plurality of grating pieces are arranged is a cylindrical surface, and the center axis thereof passes through the radiation focal point.

In the radiation detection device described in this specification, in each of the first and second gratings, the plurality of grating pieces are arranged in a second direction crossing the first direction.

In the radiation detection device described in this specification, in projection onto the radiation image detector with the radiation focal point as a viewpoint, the radiation image detector includes a fourth pixel group onto which a connection portion of adjacent grating pieces of the first grating in the second direction is projected, a fifth pixel group onto which a connection portion of adjacent grating pieces of the second grating in the second direction is projected, and a sixth pixel group excluding the fourth pixel group and the fifth pixel group. At least one pixel which belongs to the sixth pixel group is interposed between each pixel which belongs to the fourth pixel group and each pixel which belongs to the fifth pixel group.

In the radiation detection device described in this specification, in projection onto the radiation image detector with the radiation focal point as a viewpoint, projection of the center of the first grating and projection of the center of the second grating are misaligned.

In the radiation detection device described in this specification, the number of grating pieces of the first grating arranged in the second direction is different from the number of grating pieces of the second grating arranged in the second direction.

In the radiation detection device described in this specification, in at least one of the first grating and the second grating, for each column of grating pieces arranged in the second direction, the dimension of a part of the grating pieces in the second direction is different from the other grating pieces.

Also, this specification describes a radiographic apparatus. The radiographic apparatus includes the above-described radiation detection device, and a radiation source which exposes radiation to the radiation detection device.

The radiographic apparatus described in this specification further includes a scanning mechanism which moves at least one of the first grating and the second grating and places the second grating to have a plurality of relative position relationships having different phases with respect to the radiation image of the first grating. The radiation image detector detects the radiation image masked with the second grating on the basis of each relative position relationship.

This specification describes a radiographic system. The radiographic system includes the above-described radiographic apparatus, and an arithmetic section which calculates the refraction angle distribution of radiation incident on the radiation image detector from a plurality of images acquired by the radiation image detector and generates a phase contrast image of a subject on the basis of the refraction angle distribution.

In the radiographic system described in this specification, the arithmetic section calculates the refraction angle distribution by calculating the amount of phase shift of a signal of each pixel on the basis of a variation in the signal value of each pixel between the plurality of images.

This specification describes a radiographic system. The radiographic system includes the above-described radiographic apparatus, and an arithmetic section which calculates the refraction angle distribution of radiation incident on the radiation image detector from an image acquired by the radiation image detector and generates a phase contrast image of a subject on the basis of the refraction angle distribution.

In the radiographic system described in this specification, the radiation image masked with the second grating includes moire, and the arithmetic section calculates the refraction angle distribution by obtaining a spatial frequency spectrum distribution through Fourier transform on the intensity distribution of the image, separating a spectrum corresponding to the fundamental frequency of the moire from the obtained spatial frequency spectrum, and carrying out inverse Fourier transform on the separated spectrum.

This application claims foreign priority based on Japanese Patent Application Nos. JP 2010-079917 filed on Mar. 30, 2010, JP 2010-223291 filed on Sep. 30, 2010 and JP 2011-009177 filed on Jan. 19, 2011, respectively; the entire contents of which are incorporated herein by reference.

### REFERENCE SIGNS LIST

10: X-ray imaging system (radiation imaging system)

11: X-ray source (radiation source)

12: imaging unit

13: console

14: X-ray source holding device

15: upright stand

16: high voltage generator

17: X-ray source control section

18: X-ray tube

19: collimator unit

20: control device

21: input device

22: arithmetic processing section

23: storage section

24: monitor

25: I/F

30: flat panel detector (radiation image detector)

31: first transmission type grating

32: second transmission type grating (intensity modulation section)

33: scanning mechanism (intensity modulation section)

40: pixel

1. A radiation detection device comprising:
a first grating;
a second grating which has a periodic pattern substantially the same as a periodic pattern of a radiation image of the first grating formed by radiation having passed through the first grating; and
a radiation image detector which detects the radiation image masked with the second grating,
wherein each of the first grating and the second grating includes a plurality of grating pieces which are arranged at least in a first direction within a plane crossing a traveling direction of radiation passing therethrough,
in projection onto the radiation image detector with a radiation focal point as a viewpoint, the radiographic image detector includes a first pixel group onto which the connection portion of adjacent grating pieces of the first grating in the first direction is projected, a second pixel group onto which the connection portion of adjacent grating pieces of the second grating in the first direction is projected, and a third pixel group excluding the first pixel group and the second pixel group, and
at least one pixel which belongs to the third pixel group is interposed between each pixel which belongs to the first pixel group and each pixel which belongs to the second pixel group.

2. The radiation detection device according to claim 1,
wherein, in projection onto the radiation image detector with the radiation focal point as a viewpoint, projection of the center of the first grating and projection of the center of the second grating are misaligned in the first direction.

3. The radiation detection device according to claim 1,
wherein the number of grating pieces of the first grating arranged in the first direction is different from the number of grating pieces of the second grating arranged in the first direction.

4. The radiation detection device according to claim 1,
wherein, in at least one of the first grating and the second grating, for each column of grating pieces arranged in the first direction, the dimension of a part of the grating pieces in the first direction is different from the other grating pieces.

5. The radiation detection device according to claim 1,
wherein, in each of the first and second gratings, a surface in which the plurality of grating pieces are arranged is a cylindrical surface, and the center axis thereof passes through the radiation focal point.

6. The radiation detection device according to claim 1,
wherein, in each of the first and second gratings, the plurality of grating pieces are arranged in a second direction crossing the first direction.

7. The radiation detection device according to claim 6,
wherein, in projection onto the radiation image detector with the radiation focal point as a viewpoint, the radiation image detector includes a fourth pixel group onto which a connection portion of adjacent grating pieces of the first grating in the second direction is projected, a fifth pixel group onto which a connection portion of adjacent grating pieces of the second grating in the second direction is projected, and a sixth pixel group excluding the fourth pixel group and the fifth pixel group, and
at least one pixel which belongs to the sixth pixel group is interposed between each pixel which belongs to the fourth pixel group and each pixel which belongs to the fifth pixel group.

8. The radiation detection device according to claim 7,
wherein, in projection onto the radiation image detector with the radiation focal point as a viewpoint, projection of the center of the first grating and projection of the center of the second grating are misaligned.

9. The radiation detection device according to claim 7,
wherein the number of grating pieces of the first grating arranged in the second direction is different from the number of grating pieces of the second grating arranged in the second direction.

10. The radiation detection device according to claim 7,
wherein, in at least one of the first grating and the second grating, for each column of grating pieces arranged in the second direction, the dimension of a part of the grating pieces in the second direction is different from the other grating pieces.

11. A radiographic apparatus comprising:
the radiation detection device according to claim 1; and
a radiation source which exposes radiation to the radiation detection device.

12. The radiographic apparatus according to claim 11, further comprising:
a scanning mechanism which moves at least one of the first grating and the second grating and places the second grating to have a plurality of relative position relationships having different phases with respect to the radiation image of the first grating,
wherein the radiation image detector detects the radiation image masked with the second grating on the basis of each relative position relationship.

13. A radiographic system comprising:
the radiographic apparatus according to claim 12; and
an arithmetic section which calculates the refraction angle distribution of radiation incident on the radiation image detector from a plurality of images acquired by the radiation image detector and generates a phase contrast image of a subject on the basis of the refraction angle distribution.

14. The radiographic system according to claim 13,
wherein the arithmetic section calculates the refraction angle distribution by calculating the amount of phase shift of a signal of each pixel on the basis of a variation in the signal value of each pixel between the plurality of images.

15. A radiographic system comprising:
the radiographic apparatus according to claim 11; and
an arithmetic section which calculates the refraction angle distribution of radiation incident on the radiation image detector from an image acquired by the radiation image detector and generates a phase contrast image of a subject on the basis of the refraction angle distribution.

16. The radiographic system according to claim 15,
wherein the radiation image masked with the second grating includes moire, and
the arithmetic section calculates the refraction angle distribution by obtaining a spatial frequency spectrum distribution through Fourier transform on the intensity distribution of the image, separating a spectrum corresponding to the fundamental frequency of the moire from the obtained spatial frequency spectrum, and carrying out inverse Fourier transform on the separated spectrum.
